(19) United States
(12) Patent Application Publication
(10) Pub. No.: US 2008/0006117 A1
(43) Pub. Date: Jan. 10, 2008

(54) Pedal Arrangement For A Motor Vehicle

(75) Inventors: Andree Burgstaler, Dielingen (DE); Jan Duetz, Damme (DE); Wolfgang Meyer, Osnabrueck (DE); Silke Huelsmann, Ankum (DE)

Correspondence Address: MCGLEW & TUTTLE, PC, P.O. BOX 9227, SCARBOROUGH STATION, SCARBOROUGH, NY, 10510-9227, US

(73) Assignee: ZF FRIEDRICHSHAFEN AG, Friedrichshafen (DE)

(21) Appl. No.: 11/570,631

(22) PCT Filed: Jun. 15, 2005
(86) PCT No.: PCT/DE05/01061

§ 371 Date: Sep. 5, 2007

(30) Foreign Application Priority Data
Jun. 15, 2004 (DE) 10 2004 028 555.1

(51) Int. Cl. G05G 1/04; B60R 21/09; B60R 7/06

(52) U.S. Cl. 74/512

(57) ABSTRACT

A pedal arrangement for a motor vehicle is provided with a bearing block 1 having two legs 2, 3, with a bearing shaft 5 extending between the two legs 2, 3. At least one pedal is mounted on the bearing shaft 5, with two bearing elements 11, 12, which are arranged at the legs 2, 3 and which mesh with the two ends of the bearing shaft 5, and with two deformation struts 13, 14, which extend away from the two bearing elements 11, 12 starting from the bearing block 1. The two legs 2, 3 have a bearing hole each and extend into the space between the two deformation struts 13, 14, to which the bearing elements 11, 12, which pass slidably through the bearing holes, are fastened.

The present invention pertains to a pedal arrangement for a motor vehicle, with a bearing block having two legs, with a bearing shaft extending between the two legs, with at least one pedal mounted on the bearing shaft, with two bearing elements, which are arranged at the legs and mesh with the two ends of the bearing shaft, and with two deformation struts, which extend from the bearing block starting from the two bearing elements.

Such a pedal arrangement is known from the state of the art. For example, EP 0 659 615 A1 discloses a pedal mechanism for a motor vehicle, in which a pedal strut comprising two strut legs is fastened at one end to a crossbeam and with another end to the front wall of the motor vehicle. A pedal is fastened between the two strut legs by means of a pedal shaft, which is mounted pivotably in the area of its free ends by means of an axle bearing each, which is open towards the pedal shaft. The axle bearings are designed as sleeves bent out of the strut legs, whose outside diameter is smaller than the inside diameter of the pedal shaft. In case of a collision, the strong forces introduced into the pedal strut cause the two strut legs to be bent apart from one another, so that the pedal falls out of the pedal strut.

The drawback of this pedal mechanism is that the entire pedal strut is deformed and consequently unfit for use after a collision. Furthermore, it cannot be ensured that the pedal shaft is completely disengaged from the two sleeves in case of an accident, so that there is a risk that the pedal shaft gets stuck, e.g., at one of the two sleeves.

Based on this state of the art, the basic object of the present invention is to provide a pedal arrangement for a motor vehicle, in which the pedal arrangement is destroyed only slightly in case of a collision and the bearing shaft can be disengaged from the bearing elements with certainty.

This object is accomplished with a pedal arrangement for a motor vehicle in accordance with claim 1. Advantages embodiments are described in the subclaims.

The pedal arrangement according to the present invention for a motor vehicle has a bearing block having two legs, a bearing shaft extending between the two legs, at least one pedal mounted at the bearing shaft, two bearing elements, which are arranged at the legs and mesh with the two ends of the bearing shaft, and two deformation struts, which extend away from the bearing block starting from the two bearing elements. The two legs have a bearing hole each and extend into the space between the two deformation struts, at which the bearing elements passing through the bearing holes are attached.

In case of a collision, the bearing block moves towards the deformation struts in the pedal arrangement according to the present invention, so that these [struts] are pushed apart. Since the deformation struts are fastened to the bearing elements, these are pulled out of the bearing holes during the pushing apart of the deformation struts until the bearing shaft becomes disengaged from the bearing elements. The bearing shaft with the pedal is therefore no longer mounted on the bearing block and can be displaced relative to this. The bearing block, the bearing shaft, the pedal and the bearing elements now remain undamaged, as a rule, and may be replaced, if necessary. Due to the fact that the bearing elements are components separated from the bearing block, these can be completely disengaged from the bearing shaft based on the deformation of the deformation struts, so that the bearing shaft is prevented, e.g., from “getting stuck” on one side.

The two deformation struts are not made in one piece with the two legs or with the bearing block. This makes it possible to bend the two deformation struts apart in a relatively unhindered manner in case of a collision. Furthermore, the bearing block and the deformation struts may consist of different materials, and it proved to be useful to use a ductile material for the two deformation struts and a brittle material for the bearing block.

To facilitate the pushing apart of the two deformation struts in case of a collision, these extend towards one another in some areas, and the two deformation struts may have, in particular, a mirror symmetrical design in relation to one another. Sheet metal has proved to be a suitable material for the two deformation struts, which consist, e.g., of a steel or aluminum sheet.

The bearing block, made especially of plastic, preferably has a base, which connects the two legs to one another. Furthermore, PAGF (polyamide, glass fiber-reinforced) and/or PPGF (polypropylene, glass fiber-reinforced) have proved to be suitable materials for the bearing block.

The diameter of the bearing holes is preferably smaller than the outside diameter of the bearing shaft. The bearing shaft with its two front surfaces can thus come into contact with the surfaces of the two legs, which surfaces face each other, or be located at a closely spaced location therefrom in the assembled state of the pedal arrangement. Furthermore, the bearing shaft may have, at its two ends, a recess each, which is slidably engaged by the bearing elements, the bearing shaft being designed especially as a tube for reasons of stability and weight reduction.

The bearing elements, mounted slidably in the bearing holes in the axial direction, may project from the bearing holes on the sides of the two legs facing away from the bearing shaft, so that, to form the fastening between the deformation struts and the bearing elements, the deformation struts can mesh with the bearing elements, and a positive-locking connection is formed in the axial direction. At their ends facing away from the bearing shaft, the bearing elements preferably have an annular groove each for this purpose, which grooves are preferably formed in the ends of the deformation struts, which [ends] face the two legs.

To additionally fix the deformation struts at the legs, the two deformation struts may have a fixing hole each, and a projection, which meshes with the corresponding fixing hole, is provided on the sides of the two legs facing the bearing shaft. Instead of the projections or in addition to these, the deformation struts may, however, also be fastened to the legs by means of screws, which are made especially so weak that the screws are shorn off or are pulled out of the bearing block in case of a collision. Since these screws have a fixing function only and have no safety-relevant significance, the bearing block can be reused after an accident despite the fact that the screws were shorn off.

The pedal arrangement according to the present invention is used especially in a motor vehicle, which has a first motor vehicle component and a second motor vehicle component, which is moved in the direction of the first motor vehicle component in case of a collision of the vehicle. The two deformation struts with their ends used [sic—obvious typo in German original for a word meaning “facing”—Tr.Ed.] the two legs may be attached to the first motor vehicle component and the bearing block to the second motor vehicle component.

The first motor vehicle component is, in particular, a vehicle crossbeam, and the second motor vehicle component may be formed by a motor vehicle front wall separating the engine compartment from the passenger compartment. The vehicle crossbeam is fastened, for example, between the two A pillars of the motor vehicle and its position remains nearly unchanged in a collision. Contrary to this, the vehicle front wall is moved, as a rule, into the passenger compartment, towards the driver, in case of a collision, so that a relative movement of the vehicle crossbeam and the vehicle front wall takes place, which brings about the pushing apart of the two deformation struts.

Due to the fact that the bearing elements slidably mesh with the bearing shaft in the axial direction and slidably mesh with the bearing holes, only relatively weak forces are necessary for releasing the bearing shaft with the pedal or pedals.

Furthermore, the pedal arrangement according to the present invention can be manufactured with little technical effort and at a low cost and is not susceptible to component tolerances. The deformation struts may also be used to preassemble the pedal arrangement according to the present invention on the motor vehicle crossbeam, so that the pedal arrangement can be pivoted together with the cockpit into the vehicle.

Because of the small number of movable parts, the pedal arrangement according to the present invention does not tend to buckle. The tolerance chain is also not affected by the pedal arrangement according to the present invention in the area of the force transmission.

The pedal arrangement according to the present invention ensures the reliable opening of the connection between the bearing shaft and the bearing block in case of a collision, so that “carrying” of the bearing shaft with pedals due to an only one-sided opening of the connection between the bearing shaft and the bearing block can be prevented from occurring.

Furthermore, the requirement that the pedals, especially the brake pedals, be released in case of a crash of the vehicle only in connection with an intrusion of the pedal mechanism into the passenger compartment, which is desired by the automobile manufacturers, can be met. The pedal arrangement according to the present invention may also be supplied as a complete pedal module.

The present invention will be described below on the basis of preferred embodiments in reference to the drawings. In the drawings,

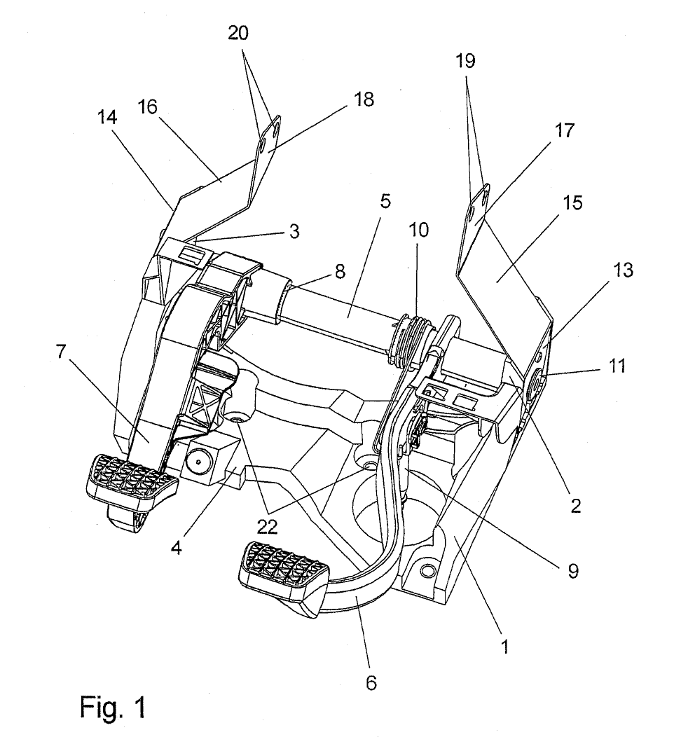

FIG. 1 shows a perspective view of the pedal arrangement according to the present invention according to a first embodiment in the assembled state,

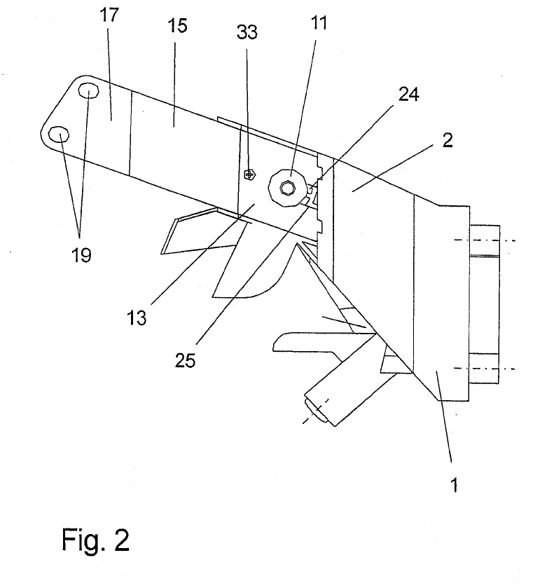

FIG. 2 shows a side view of the embodiment according to FIG. 1 without pedals,

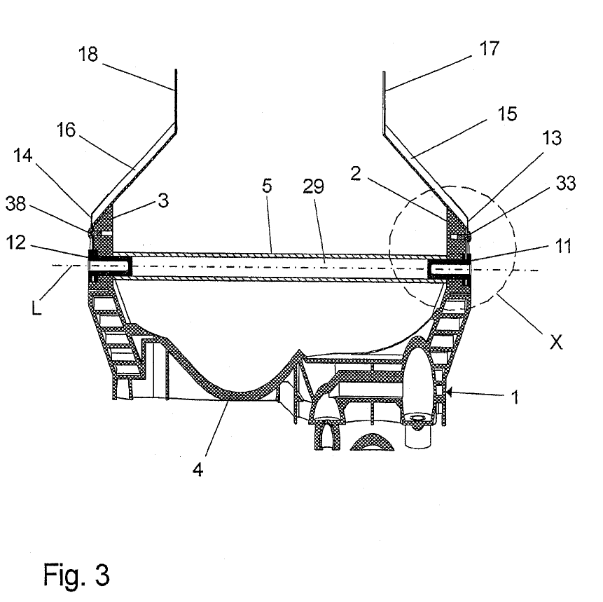

FIG. 3 shows a sectional view of the embodiment according to FIG. 1 without pedals,

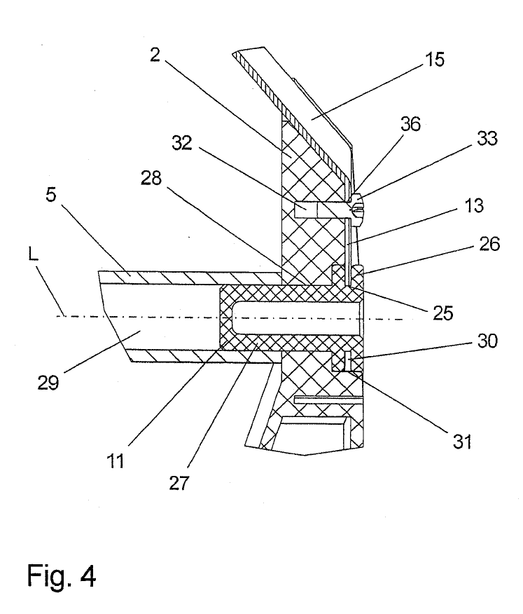

FIG. 4 shows an enlarged view of the area marked by X in FIG. 3,

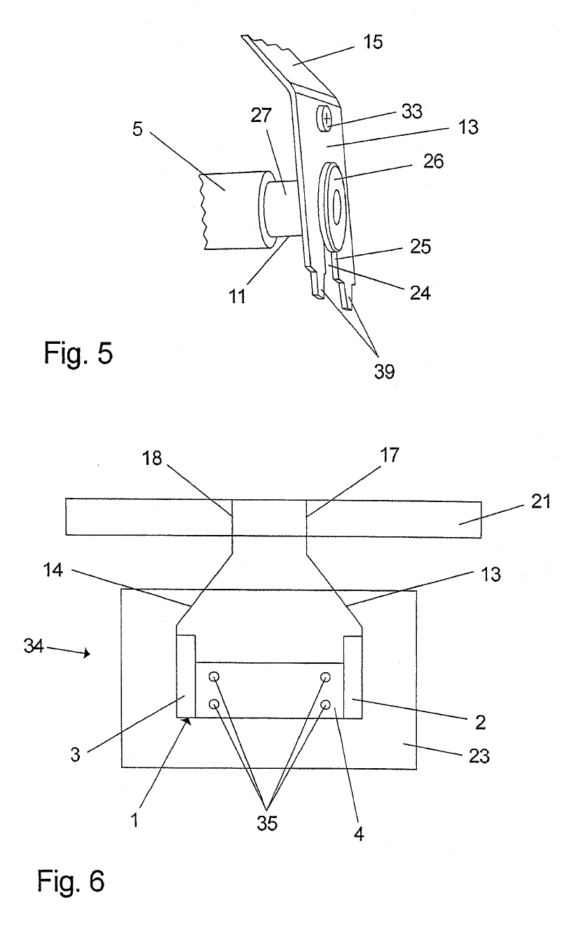

FIG. 5 shows a perspective partial view of the area of a deformation strut according to FIG. 1, which said area faces the bearing block,

FIG. 6 shows a schematic partial view of a motor vehicle, in which the pedal arrangement according to FIG. 1 is installed, and

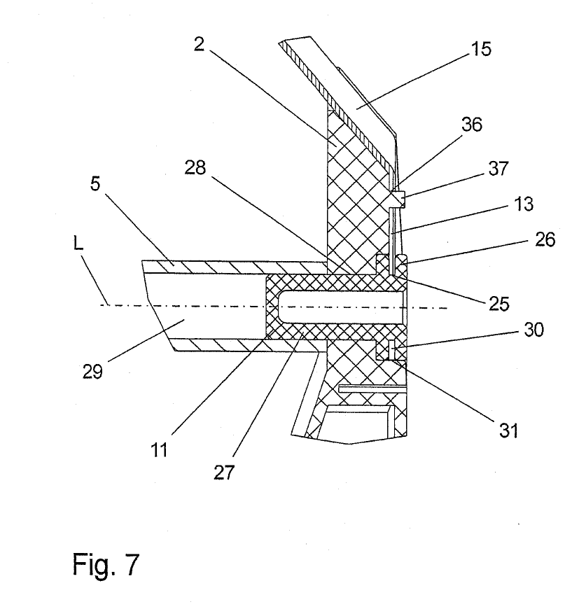

FIG. 7 shows a partial sectional view of a pedal arrangement according to the present invention according to a second embodiment.

FIG. 1 shows a perspective view of the pedal arrangements according to the present invention according to a first embodiment in the uninstalled state, wherein a bearing block 1 made of a plastic has two legs 2 and 3, which are connected to one another via a base 4. A bearing shaft 5, at which a brake pedal 6 and a clutch pedal 7 are mounted, is arranged between the two legs 2 and 3, a bearing sleeve 8 being provided between the clutch pedal 7 and the bearing shaft 5. The brake pedal 6 is connected to a brake booster (not shown) via a coupling rod 9 and can be reset by a spring 10 after actuation into its inoperative position.

The bearing shaft 5 is mounted via bearing elements 11 and 12 (see FIG. 3) at the two legs 2 and 3, which are arranged between two deformation struts 13 and 14. The deformation struts 13 and 14 are in contact on the sides of the two legs 2 and 3 facing away from the bearing shaft 5 and extend away from the base 4 in the direction of a vehicle crossbeam 21 (see FIG. 6). Furthermore, the two deformation struts 13 and 14 have a respective bevel 15 and 16, the distance between the two bevels 15 and 16 decreasing with increasing distance from the two legs 2 and 3. A fastening area 17 and 18 each, which is provided with holes 19 and 20 for fastening the deformation struts 13 and 14 to the vehicle crossbeam 21, adjoins the ends of the two bevels 15 And 16, which said ends face away from the two legs 2 and 3. The two fastening areas 17 and 18 extend essentially in parallel to one another. Furthermore, a plurality of holes 22 are provided in the base 4, so that the bearing block 1 can be fastened to a vehicle front wall 23 (see FIG. 6).

FIG. 2 shows a side view of the embodiment according to FIG. 1 without pedals 6 and 7, the deformation strut 13 having, at its end facing the leg 2, a slot 24, whose edges 25 mesh with an annular groove 30 (see FIG. 4) provided in the bearing element 11.

FIG. 3 shows a sectional view of the embodiment according to FIG. 1, wherein the clutch pedal 7, the bearing sleeve 8, the brake pedal 6, the coupling rod 9 and the spring 10 were omitted for reasons of clarity. It can be seen that the bearing elements 11 and 12 pass through the legs 2 and 3 and extend into the interior space of the bearing shaft 5 designed as a tube. The bearing elements 11 and 12 are mounted axially slidably in both legs 2 and 3 and the interior space 29 of the bearing shaft 5 in the direction of the longitudinal axis L thereof and are fastened to the two deformation struts 13 and 14.

FIG. 4 shows an enlarged view of the area marked by X in FIG. 3. The bearing element 11 has a section 27 of constant diameter, which extends through a bearing hole 28 provided in the leg 2 and into the interior space 29 of the bearing shaft 5. The bearing element 11 is mounted slidably with the section 27 in the longitudinal direction L in the bearing hole 28 and in the interior space 29 and is fixed in the axial direction by the deformation strut 13 only, which meshes with the annular groove 30 formed in the head area 26 of the bearing element 11 with the edges 25 of the slot 24. The head area 26 has a larger diameter here than the section 27 and is seated in a recess 31 provided in the leg 2.

The leg 2 has a hole 32, which is open towards the deformation strut 13 and into which a screw 33 passing through a hole 36 provided in the deformation strut 13 is screwed, the head of the screw having a larger diameter than the hole 36. The screw 33, which is used only to fix the deformation strut 13, is so weak that it can be shorn off or pulled out of the leg 2 in case of a collision, without offering an appreciable resistance to the pushing apart of the two deformation struts 13 and 14.

Even though only the fastening of one end of the bearing shaft 5 to the leg 2 is shown in FIG. 4, the bearing shaft 5 is also fastened in a corresponding manner with its other end to the leg 3 via the bearing element 12 and the deformation strut 14. Furthermore, the deformation strut 14 is fixed by means of a screw 38 to the leg 3, and this screw is so weak, analogously to the screw 33, that it can be shorn off or pulled out of the leg 3 in case of a collision without offering an appreciable resistance to the pushing apart of the two deformation struts 13 and 14.

FIG. 5 shows a perspective partial view of the deformation strut 13 with the bearing shaft 5 shown partially, with the bearing block 1 having been omitted. The deformation strut 13 has, at its end facing the bearing block 1, two lugs 39, which mesh with clearances (not shown) formed in the bearing block 1 and act as fixing aids. Although not shown, the deformation strut 14 is also provided at its end facing the bearing block 1 with two lugs, which mesh with clearances off the bearing block 1.

FIG. 6 shows a schematic partial view of a motor vehicle 34, in which the pedal arrangement according to FIG. 1 is shown in the installed state. Of the pedal arrangement, only the pedal block 1 with the two legs 2 and 3, the base 4 and the two deformation struts 13 and 14 is shown for reasons of clarity. As is apparent from FIG. 6, the bearing block 1 is fastened to the vehicle front wall 23 by means of screws 35 passing through the holes 22, whereas the two deformation struts 13 and 14 with their fastening areas 17 and 18 are fastened to the vehicle crossbeam 21.

FIG. 7 shows a partial sectional view of a pedal arrangement of a second embodiment according to the present invention, wherein identical or similar features are designated by the same reference numbers as in the first embodiment. A projection 37, which meshes with the hole 36 provided in the deformation strut 13, is provided on the side of the leg 2 facing away from the pedal shaft 5. This projection 37 assumes the fixing function of the deformation strut 13 at the leg 2, so that the hole 32 and the screw 33, which are provided according to the first embodiment, may be omitted. The fixation of the deformation strut 14 to the leg 3 is designed in a corresponding manner. However, the two embodiments have an identical design aside from these two fixations and possibly the lugs.

### LIST OF REFERENCE NUMBERS

1 Bearing block
2 Leg of bearing block
3 Leg of bearing block
4 Base of bearing block
5 Bearing shaft
6 Brake pedal
7 Clutch pedal
8 Bearing sleeve for clutch pedal
9 Coupling rod for brake pedal
10 Spring for brake pedal
11 Bearing element for bearing shaft
12 Bearing element for bearing shaft
13 Deformation strut
14 Deformation strut
15 Bevel
16 Bevel
17 Fastening area
18 Fastening area
19 Holes in fastening area
20 Holes in fastening area
21 Vehicle crossbeam
22 Holes in base
23 Vehicle front wall
24 Slot in deformation strut
25 Edges of slot
26 Head area of bearing element
27 Section of bearing element
28 Bearing hole in leg
29 Interior space of bearing shaft
30 Annular groove in bearing element
31 Recess in leg
32 Hole in leg
33 Fixing screw
34 Motor vehicle
35 Screws
36 Hole in deformation strut
37 Projection on leg
38 Fixing screw
39 Lugs on deformation strut

1. A pedal arrangement for a motor vehicle, the pedal arrangement comprising;
a bearing block having two legs;
a bearing shaft extending between said two legs;
at least one pedal mounted on said bearing shaft;
two bearing elements arranged at respective said legs which respectively mesh with two ends of said bearing shaft; and
two deformation struts extending respectively away from said two bearing elements starting from said bearing block, said two legs having a bearing hole each and said legs each respectively extending into a space between said two deformation struts said bearing elements being fastened to respective said deformation struts, and said bearing elements passing slidably through a respective one of said bearing holes.

2. Apedal arrangement in accordance with claim 1, wherein said two deformation struts are not made in one piece with said two legs.

3. A pedal arrangement in accordance with claim 1, wherein said two deformation struts extend towards each other in an area.

4. A pedal arrangement in accordance with claim 1, wherein said two deformation struts have a mirror symmetrical design in relation to one another.

5. A pedal arrangement in accordance with claim 1, wherein said two deformation struts consist of sheet metal.

6. A pedal arrangement in accordance with claim 1, wherein said bearing block has a base connecting said two legs to one another.

7. A pedal arrangement in accordance with claim 1, wherein said bearing block consists of a plastic.

8. A pedal arrangement in accordance with claim 1, wherein the diameter of said bearing holes is smaller than the outside diameter of said bearing shaft.

9. A pedal arrangement in accordance with claim 1, wherein said bearing shaft has at both ends thereof a recess each, with which mesh said bearing elements.

10. A pedal arrangement in accordance with claim 1, wherein said bearing shaft is designed as a tube.

11. A pedal arrangement in accordance with claim 1, wherein said bearing elements extend out of said bearing holes on the sides of said to legs facing away from said bearing shaft.

12. A pedal arrangement in accordance with claim 1, wherein said deformation struts mesh with said bearing elements.

13. A pedal arrangement in accordance with claim 1, wherein an annular groove each, with which said respective deformation strut meshes, is provided at the ends of said bearing elements facing away from said bearing shaft.

14. A pedal arrangement in accordance with claim 13, wherein in ends facing said two legs, said deformation struts each have a slot having edges that mesh with said respective annular groove.

15. A pedal arrangement in accordance with claim 1, wherein said two deformation struts are fixed to said legs with a screw each.

16. A pedal arrangement in accordance with claim 1, wherein on their sides facing each other, said two legs each have a projection, which meshes with a hole provided in said respective deformation strut.

17. A pedal arrangement in accordance with claim 1, wherein at their ends facing said bearing block, said two deformation struts have at least one said lug, which meshes with said bearing block.

18. A motor vehicle with a pedal arrangement in accordance with claim 1, with further comprising:
a first motor vehicle component;
a second motor vehicle component, which is moved in the direction of said first motor vehicle component in case of a collision of said vehicle, wherein said two deformation struts are fastened to said first motor vehicle component and said bearing block is fastened to said second motor vehicle component.

19. A motor vehicle in accordance with claim 18, wherein said first motor vehicle component is a vehicle crossbeam and said second motor vehicle component is formed by a motor vehicle front wall.

20. A motor vehicle with a pedal arrangement:
a bearing block having a first side leg and a second side leg;
a bearing shaft extending between said first side leg and said second side leg;
a pedal mounted on said bearing shaft;
a first bearing element engaged with a first end of said bearing shaft;
a second bearing element engaged with a second end of said bearing shaft;
a first side deformation strut extending away from said first bearing element, starting from said bearing block;
a second side deformation strut extending away from said second bearing element, starting from said bearing block, said first side leg having a first leg bearing hole and said first side leg extending into a space between said first deformation strut and said second deformation strut, said second side leg having a second leg bearing hole and said second side leg extending into a space between said first deformation strut and said second deformation strut, said first bearing element being fastened to said first deformation strut, said second bearing element being fastened to said second deformation strut, said first bearing element passing slidably through said first leg bearing hole and said second bearing element passing slidably through said second leg bearing hole;
a first motor vehicle component fastened to each of said first deformation strut and said second deformation strut; and
a second motor vehicle component designed and situated to be movable in a direction of said first motor vehicle component during a collision of said vehicle, said second motor vehicle component being fastened to said bearing block.
